(19) United States
(12) Patent Application Publication
(10) Pub. No.: US 2008/0156237 A1
(43) Pub. Date: Jul. 3, 2008

(54) Combustor for solid particulate fuels

(76) Inventor: Joseph Q. Leihgeber, Williamsburg, OH (US)

Correspondence Address: LITMAN LAW OFFICES, LTD., P.O. BOX 15035, CRYSTAL CITY STATION, ARLINGTON, VA, 22215, US

(21) Appl. No.: 11/646,471

(22) Filed: Dec. 28, 2006

(51) Int. Cl. F23G 5/32; F27B 9/00

(52) U.S. Cl. 110/258; 432/135; 432/152

(57) ABSTRACT

The combustor for solid particulate fuels is particularly well suited for burning shelled corn, but is also capable of burning other solid particulate fuels as desired, with no modification required for their use. The combustor includes a rotary agitator extending across the combustor chamber or “burning pot,” with the agitator having a plurality of radial arms. Combustion air passes through the hollow agitator shaft outwardly through the hollow arms, the arms distributing combustion air into the fuel mass as the arms rotate therethrough to produce more efficient combustion of the fuel and thereby reduce coagulation of partially burned corn on the internal surfaces of the combustor. The opposed walls of the combustor include at least one pivotally mounted wall, with the angle of that wall being adjustable to adjust the ash dispersal gap between the pivoting wall and the opposite wall.

### BACKGROUND OF THE INVENTION

1. Field of the Invention

The present invention relates generally to furnaces, stoves, and heating appliances. More particularly, the present invention relates to a combustor for solid particulate fuels that provides a “burning pot” for a furnace or stove, with the device configured particularly for burning shelled corn kernels. The combustor may also burn other solid particulate fuels.

2. Description of the Related Art

The basic concept of the space heater is generally considered to have originated in the Franklin stove of the eighteenth century. Since that time, innumerable improvements, refinements, additions, and modifications have been developed for the device. Initially, these devices burned wood cut to appropriate dimensions, with a grate used to elevate the wood from the bottom of the stove for more efficient air circulation and combustion.

Later, solid particulate fuels (e.g., coal) were used in such stoves, with coal proving to be a more efficient fuel than wood. However, this necessitated some modification to the grate in order to hold the burning coal, with other modifications (e.g., fuel feeding or delivery systems, etc.) being developed as well.

Even more recently, such stoves have been used to burn a variety of biomass materials in order to produce heat. Many such biomass materials are otherwise considered waste byproducts, e.g., corn cobs, wood chips, etc., unusable for other purposes. While most such fuels are not particularly efficient, they have the advantage of being quite economical and may cost nothing if a supply is readily available, as in some rural areas.

However, it has been found that the inefficiency of such biomass fuels requires considerably more labor for the user than do more efficient fuels, as more of the inefficient fuel must be transported to the stove and placed in the stove for burning, and such fuel generally produces a relatively greater quantity of ash and other incombustible byproducts than do more efficient fuels. As such, many persons are finding the use of such inefficient fuels to be not worth the bother, even if they cost nothing.

The quest for a reasonably efficient, yet economical fuel is a never ending process. One fuel that meets the above requirement is shelled corn, which has relatively recently begun to be used as a fuel in such stoves. Corn is not without its drawbacks, however. For example, corn kernels are so small that they would fall through virtually any form of grate that is sufficiently massive to withstand the temperatures produced in a stove or furnace. Thus, a solid floor for the combustor or “burning pot” is a requirement of such stoves. However, this results in the problem of introducing sufficient air through the fuel mass for proper combustion if the mass is resting upon the solid floor of the combustion chamber. Accordingly, a number of agitators have been developed for stoves burning fuels in the form of small solid particulates (wood pellets, shelled corn, etc.).

Many users of such stoves have begun burning corn in their stoves, as noted further above. Corn has some unique properties when burned as a fuel, with one of those characteristics being that it becomes somewhat sticky as it undergoes the chemical changes resulting from the combustion process. This results in the corn kernels tending to stick and clump together, thereby reducing their combined surface area for their mass and resulting in incomplete combustion of the conglomerate mass. Moreover, the corn tends to adhere to the interior surfaces of the combustor assembly (i.e., the agitator and interior walls of the combustor). Many users of such stoves have discovered this, and have found that they must frequently scrape congealed masses of incompletely burned corn from various components within their stoves. Nevertheless, owners of such stoves have continued to use corn as a fuel, due to its relative economy and excellent heat output per unit of mass. Although various stove manufacturers have attempted to produce stoves that avoid the above problem, they have not been entirely successful.

Thus, a combustor for solid particulate fuels solving the aforementioned problems is desired.

### SUMMARY OF THE INVENTION

The combustor for solid particulate fuels provides a combustor assembly that is configured particularly well for using shelled corn as a fuel. However, the combustor may also burn other solid particulate fuels (e.g., wood pellets, cherry pits and the like, etc.). The combustor provides a structure that is configured to avoid the problem of coagulation of heated, partially burned corn kernels in such devices.

One portion of the solution is the agitator configuration, with the agitator comprising a hollow rotary axle tube with a series of hollow arms radiating therefrom. The arms have a series of combustion air outlet passages therein extending to their distal ends. Combustion air is provided from an outside source and passes through the rotary axle tube, and thence out of the air outlet passages of the arms and into the combustor interior. The agitator arms are constantly rotating during operation of the stove, and thus deliver combustion air throughout the fuel mass as it is stirred by the arms. The more efficient and complete combustion of the fuel mass due to the introduction of combustion air into the mass by the agitator arms greatly reduces the problem of coagulation of the partially burned fuel onto the interior components of the combustor when corn is used as the fuel. The combustion air outlet passages of the agitator are also specifically configured to avoid adhesion of partially burned corn or other fuel pellets therein, thus avoiding the problem of blockage of the air outlets.

The second portion of the solution provided by the configuration of the walls of the combustor assembly. First and second opposed walls having a generally J-shaped cross section are provided between opposed, spaced apart end panels. The two curved panels form front and rear walls for the combustor assembly, as well as forming two separate halves of the floor of the combustor. At least one of the front and rear panels is pivoted along its upper edge, with an adjuster being provided to adjust the angle of the pivoted panel as it is suspended from its support rod. The adjustment of the pivotally-mounted panel also adjusts the ash dispersal gap defined between the lower edges of the two panels. This assures that the unburned fuel will remain within the combustor chamber without falling through to the ash collection pan therebelow, while still allowing smaller particles of ash and burned fuel to fall through the gap defined by the two panels and into the ash collection pan.

These and other features of the present invention will become readily apparent upon further review of the following specification and drawings.

### BRIEF DESCRIPTION OF THE DRAWINGS

FIG. 1 is a partially broken away perspective view of a combustor for solid particulate fuels according to the present invention, showing various details thereof.

FIG. 2 is a side elevation view in section of the combustor of FIG. 1, showing further details thereof.

FIG. 3 is an end elevation view in section of the combustor of FIGS. 1 and 2, showing further details thereof.

FIG. 4 is a broken away detailed elevation view of the lower portions and edges of the side panels of a combustor for solid particulate fuels according to the present invention, showing their specific configuration.

FIG. 5 is a broken away detailed elevation view of an exemplary agitator arm of a combustor for solid particulate fuels according to the present invention, showing its specific configuration.

Similar reference characters denote corresponding features consistently throughout the attached drawings.

### DETAILED DESCRIPTION OF THE PREFERRED EMBODIMENT

The present invention is a combustor or “burning pot” for stoves and the like, configured for burning solid particulate fuels (e.g., compressed wood pellets, coal, etc.). The combustor is configured particularly for burning shelled corn, i.e., loose individual kernels of corn. It is recognized by those who use corn to generate heat that corn tends to adhere to itself and to other objects when heated before it is completely burned. Accordingly, the combustor is configured to overcome this tendency for corn to clump together during the burning process, thereby resulting in complete combustion of the corn for more efficient heat generation and finer ash residue from the burned corn.

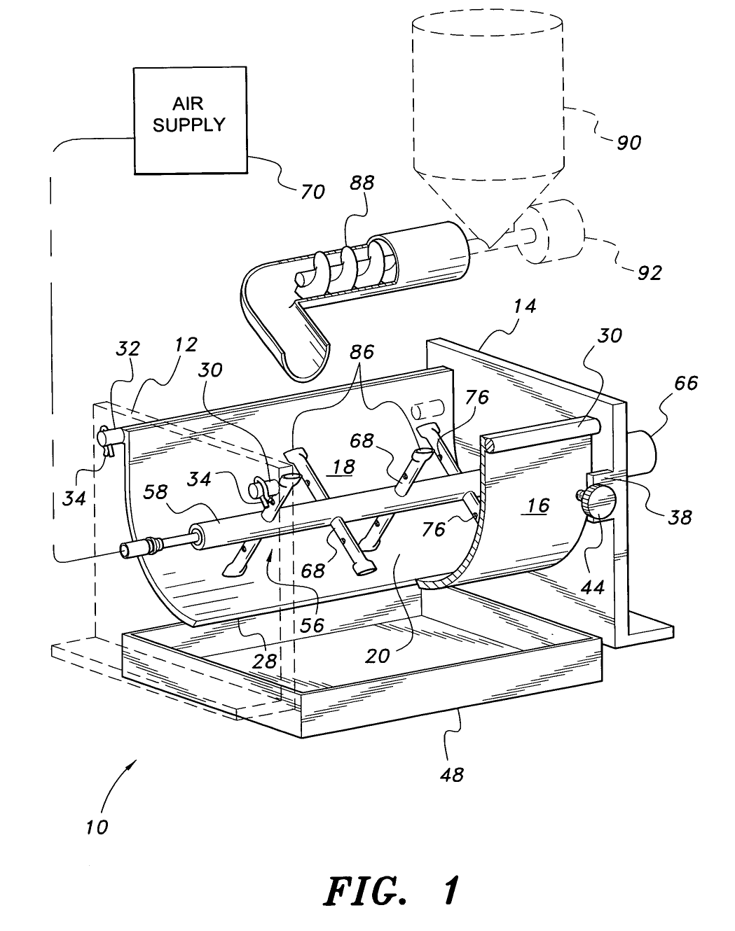

FIG. 1 of the drawings provides a partially broken away perspective view of the present combustor 10, illustrating its various components and their assembly with one another. The combustor 10 includes opposite, spaced apart first and second end walls, respectively 12 and 14, with opposite, spaced apart first and second side panels 16 and 18 extending between the end walls 12 and 14. The end walls 12 and 14 and side panels 16 and 18 define a combustor well or volume 20 in which solid particulate fuel is burned to produce heat.

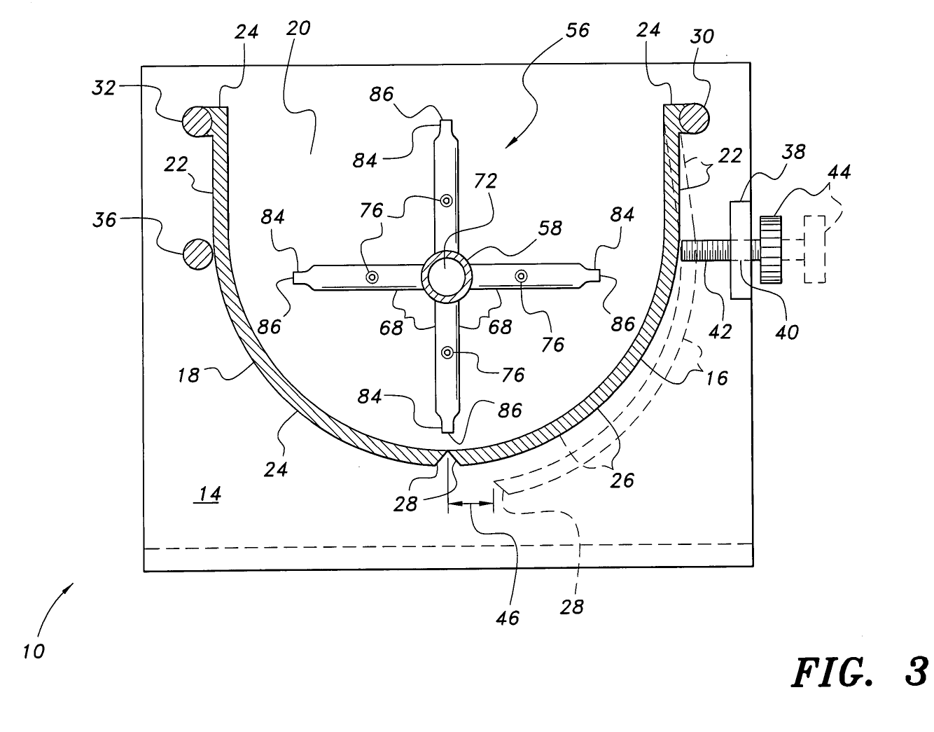

FIG. 3 of the drawings provides an end elevation view in section of the combustor 10, showing the cross-sectional shape of the two side panels 16 and 18. Each of the two side panels has a generally J-shaped cross section, with a generally vertical upper portion 22 with an upper edge 24 and a curved lower portion 26 with a lower edge 28. The two side panels 16 and 18 are installed between the two end walls 12 and 14 in mirror image to one another, with the two concave sides of the lower portions 26 and their lower edges 28 facing one another and forming the floor or bottom of the combustor volume 20.

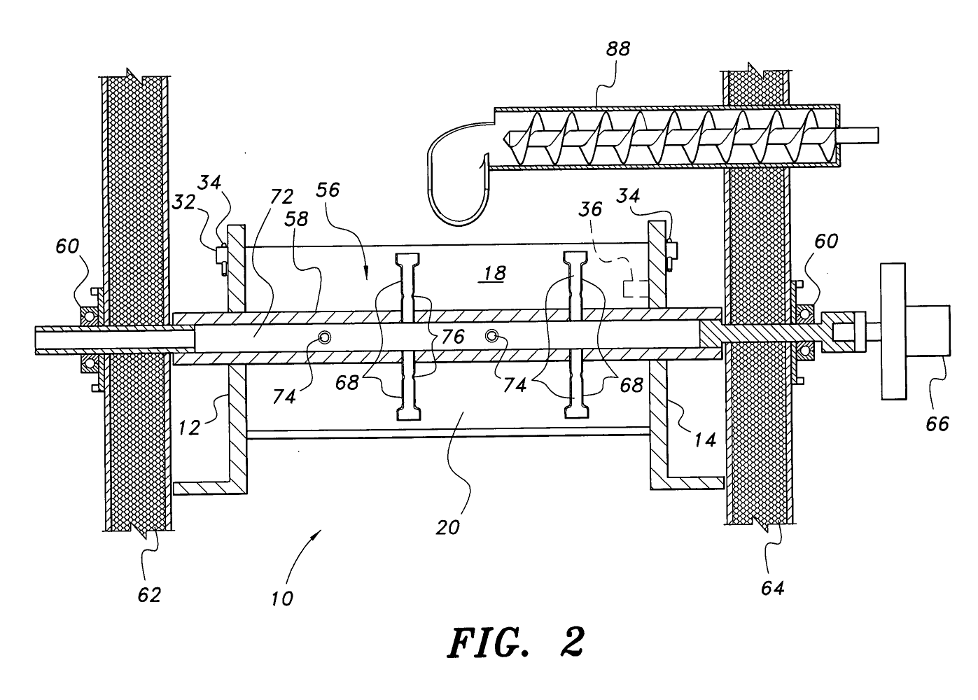

The two panels 16 and 18 are welded (or otherwise permanently and immovably affixed) to first and second side panel support rods 30 and 32, with the two support rods 30 and 32 being pivotally mounted between the two end walls 12 and 14. The support rods 30 and 32 may be removed from the end walls 12 and 14 by removing the cotter pins 34 (shown in FIGS. 1 and 2), or other retaining pin or keeper, from their ends in order to provide for compact transport and storage of the combustor assembly.

Preferably, the second side panel 18 is non-adjustable when installed between the two end walls 12 and 14, even though it is pivotally secured between the two end walls 12 and 14. A second side panel stop rod 36 extends from one of the end walls, e.g., the second end wall 14, vertically below the second side panel support rod 32. This prevents the second side panel 18 from swinging outwardly away from the opposite first side panel 16, when the components are assembled. The stop rod 36 need not be very long, as it only needs to contact the second side panel 18 at one point therealong to prevent movement of the entire side panel 18. Alternatively, the second side panel 18 could be welded or otherwise permanently and immovably affixed between the two end walls 12 and 14 if disassembly of the combustor is not required.

The first side panel 16 is secured between the two end walls 12 and 14 in a manner similar to that used for the second end panel 18, i.e., by the first panel support rod 30 being pivotally secured between the two end walls 12 and 14 and held in place by retainers 34 (roll pins, cotter pins, etc.). However, rather than limiting the arcuate or pivotal motion of the first panel 16 by a fixed stop, as was done with the second panel 18, an adjustable stop is provided for the first panel 16. The adjustable stop comprises a fixed plate 38 extending from one of the two end walls, e.g., the second end wall 14. The adjustor plate 38 has a threaded passage 40 therethrough (shown in FIG. 3), with a mating threaded rod or shaft 42 installed therein. Turning the adjuster knob 44 on the end of the rod 42 advances or retracts the rod 42 relative to the fixed adjustor plate 38, thereby allowing the first side panel 16 to pivot away from the second side panel 18 or urging the first side panel toward the second side panel 18. This provides adjustment for the ash dispersal gap 46 defined between the lower edges 28 of the two side panels 16 and 18, as shown clearly in FIG. 3 of the drawings. The ash dispersal gap 46 is adjusted to a width slightly smaller than the diameter or width of the solid particulates of the fuel being burned within the combustor 10, e.g., corn kernels, etc. This retains the fuel within the combustor volume 20 during operation of the combustor, preventing any of the fuel from falling through the ash dispersal gap 46 while still burning or in an unburned state. Yet, once the fuel has been burned, it no longer retains its solidity, and the fragments and ashes pass easily through the ash dispersal gap 46 and into the underlying ash pan 48.

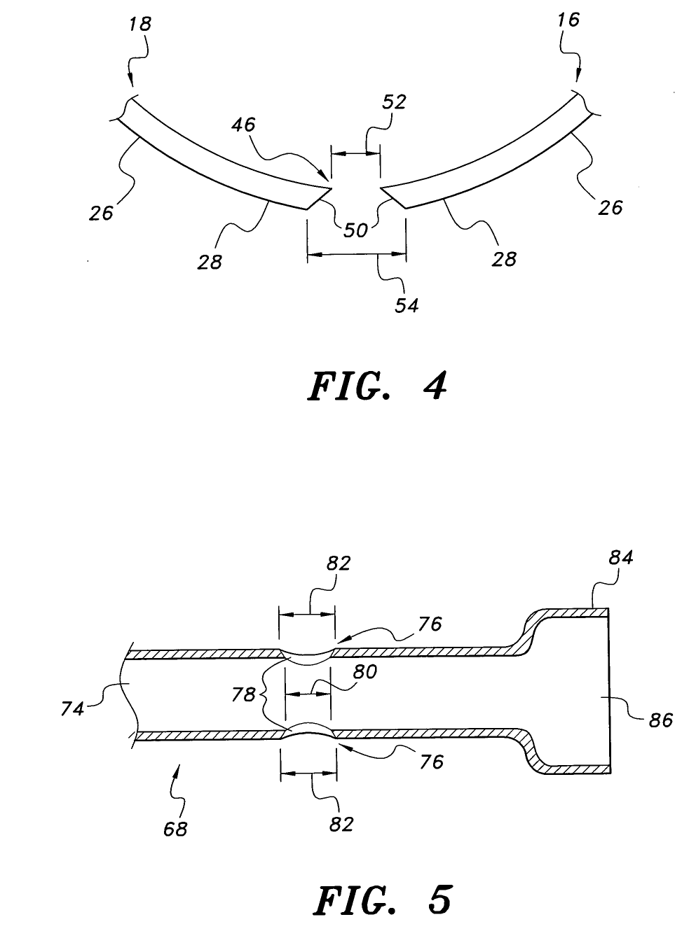

FIG. 4 of the drawings provides a more detailed view of the specific configuration of the ash dispersal gap 46. The lower edges 28 of the two side panels 16 and 18 each have a continuous bevel 50 formed therealong, with the angular taper of the bevel 50 forming a relatively narrow inlet 52 and relatively wider outlet side 54 for the ash dispersal gap 46. This beveled configuration results in any particulate matter that can pass through the narrow inlet slot 52 at the top of the beveled edges continuing to fall through the wider outlet side 54 defined by the lower edges 28 of the two panels 16 and 18, rather than jamming between the two panel lower edges and clogging the ash dispersal gap or slot 46.

The combustor 10 includes other mechanisms providing for complete combustion of the particulate fuels burned therein, and for preventing the coagulation or clumping together of the fuel particles during the burning process. This is accomplished by a rotary agitator assembly 56, which extends the length of the combustor 10 between the two end walls 12 and 14. The agitator assembly 56 includes an elongate hollow agitator shaft 58, which is supported by rotary bearings 60 disposed outboard of the two end walls 12 and 14 on the outer walls of the respective first and second insulation panels 62 and 64 surrounding the combustor 10, as shown in FIG. 2. Rotation may be provided by a suitable electric motor and rotational speed reduction assembly 66, as indicated to the outboard side of the second insulation panel 64 in FIG. 2.

A series of hollow, tubular agitator arms 68 extend radially from the hollow shaft 58, and provide combustion air to the particulate fuel within the combustor 10. Combustion air is provided by an outside air source 70 (e.g., electrically powered fan, air compressor, etc., shown generally in FIG. 1) to the combustion air passage 72 of the rotary shaft 58 (FIGS. 2 and 3) via a conventional rotary or swivel coupling at the inlet end of the shaft 58, and thence to the connected combustion air passages 74 within each of the hollow agitator arms 68. Preferably, a source of relatively high volume, low pressure air is provided, e.g., a fan, “squirrel cage” blower, etc. However, higher pressure air may be provided by a compressor, if necessary, with appropriate pressure regulation upstream of the agitator shaft 58.

Each of the agitator arms 68 includes a plurality of lateral combustion air outlets 76 extending radially from the axial combustion air passages 74 of the respective agitator arms 68. The combustion air outlets 76 of the agitator arms 68 are configured similarly to the beveled edges 50 of the lower edges 46 of the two side panels 16 and 18, in that each of the outlet holes 76 includes a bevel 78. FIG. 5 provides a detailed cross-sectional view of an exemplary agitator arm 68 and its beveled outlets 76. The bevels 78 of each of the holes or outlets 76 are configured to provide a relatively narrow inlet or interior side 80 smaller than the size of the individual particles of the particulate fuel being burned, and a relatively wider outlet side 82. This beveled configuration of the combustion air outlet passages 76 assures that fuel particles cannot pass through the combustion air outlet holes 76 and into the interiors of the agitator arms 68 and rotary agitator shaft 58 in the event that no air flow is being provided through the agitator assembly 56. Moreover, the outwardly beveled configuration of the combustion air outlet passages 76 results in fuel particles being deflected away from the holes 76 by the angular shape of the bevels 78.

The agitator arms 68 also deliver combustion air from their distal ends 84. However, the ends 84 of the arms 68 are crimped or flattened to narrow the outlet ends 84 to a relatively wide and thin combustion air outlet slot 86, as shown particularly in FIGS. 1 and 3 of the drawings. This restricts airflow from the distal ends 84 of the agitator arms 68, thereby producing a greater flow of air from the lateral passages 76 of the arms than would otherwise be the case. Also, the smaller cross-sectional area of the outlet slots 86 of the arms 68 results in an acceleration of the airflow therethrough, which serves to agitate the particles of fuel within the combustor 10 and to break up any clumps that may otherwise tend to form.

Fuel may be placed manually within the combustor volume 20, if so desired, but preferably the fuel is delivered by some automated means, such as the exemplary fuel delivery auger 88 shown in FIGS. 1 and 2 of the drawings. The auger 88 receives fuel from a hopper 90 and is powered by an electric motor 92, with the hopper 90 and auger drive motor 92 being shown in broken lines in FIG. 1. The fuel delivery process may be automated by conventional temperature and/or other sensors, as is known in the art of combustion heating. Ignition may be accomplished manually by initially igniting a fuel having a relatively low ignition point and using that fuel to ignite the main fuel being used. Alternatively, an electronic ignition source may be provided.

The agitator assembly 56 is then actuated, either by manually closing a switch to operate the agitator drive motor 66 or by automated means, if so equipped. The air supply 70 is also initiated to provide a continuous supply of combustion air to the fuel within the combustor volume 20 through the agitator assembly 56 and its combustion air passages 72 and 74. The volume of air delivered from the outlet ports 76 and 86 of the agitator arms 68, results in extremely efficient combustion of the fuel within the combustor assembly. The rotation of the agitator arms 68, in combination with the flow of air from the air passages 72 and 74, breaks up any accretions of fuel that might otherwise tend to form within the combustor. The rotation further precludes the adhesion of fuel particles upon the inner walls of the combustor 10 and/or upon the agitator assembly 56. The result is an extremely efficient and cost effective heating system, which is also very low in maintenance requirements due to the efficient combustion process and elimination of accretions of partially burned fuel. Accordingly, the combustor for particulate fuels 10 will be greatly appreciated by those who burn shelled corn and/or other particulate fuels for heat.

It is to be understood that the present invention is not limited to the embodiment described above, but encompasses any and all embodiments within the scope of the following claims.

1. A combustor for solid particulate fuels, comprising:
a first end wall;
a second end wall opposite the first end wall;
opposing first and second side panels extending between the first end wall and the second end wall, each of the side panels having a generally J-shaped cross section with a generally vertical upper portion defining an upper edge and a curved lower portion defining a lower edge, the side panels being disposed in mirror image to one another, the lower edges of the side panels facing one another and defining an adjustable ash dispersal gap therebetween;
a rotary agitator disposed between the first end wall and the second end wall, the agitator having;
an elongate, hollow agitator shaft defining a combustion air passage disposed axiallytherethrough; and
a plurality of agitator arms extending radially from the agitator shaft, each of the agitator arms defining a combustion air passage disposed axially therethrough and communicating with the combustion air passage of the agitator shaft, each of the agitator arms having a plurality of combustion air outlets disposed therethrough communicating with the combustion air passage of the agitator arm, wherein each of the agitator arms has a flattened distal end defining a narrow combustion air outlet slot therein.

2. The combustor for solid particulate fuels according to claim 1, further comprising:
a first side panel support rod pivotally and removably disposed between the first end wall and the second end wall, the upper edge of the first side panel being fixed to the first side panel support rod; and
a first side panel adjuster extending from one of the end walls and adjustably contacting the first side panel, thereby adjusting the ash dispersal gap between the lower edge of the first side panel and the lower edge of the second side panel.

3. The combustor for solid particulate fuels according to claim 1, further comprising:
a second side panel support rod pivotally and removably disposed between the first end wall and the second end wall, the upper edge of the second side panel being fixed to the second side panel support rod; and
a second side panel stop fixed to and extending from at least one of the end walls, the second side panel stop abutting the second side panel and precluding motion thereof away from the first side panel.

4. The combustor for solid particulate fuels according to claim 1, wherein the lower edges of the first side panel and the second side panel each have a continuous bevel disposed therealong, the ash dispersal gap having a narrow inlet and a wide outlet extending continuously along the first side panel and the second side panel.

5. The combustor for solid particulate fuels according to claim 1, wherein each of the combustion air outlets has a beveled wall defining the outlet, the beveled wall having a narrow inlet and a wide outlet.

6. (canceled)

7. A combustor for solid particulate fuels, comprising:
a first end wall;
a second end wall opposite the first end wall;
opposing first and second side panels extending between the first end wall and the second end wall, each of the side panels having a generally J-shaped cross section with a generally vertical upper portion defining an upper edge and a curved lower portion defining a lower edge, the side panels being disposed in mirror image to one another, the lower edges of the side panels facing one another and defining an adjustable ash dispersal gap therebetween, wherein the lower edges of the first side panel and the second side panel each have a continuous bevel disposed therealong, with the ash dispersal gap having a narrow inlet and a wide outlet and extending continuously along the first side panel and the second side panel.

8. The combustor for solid particulate fuels according to claim 7, further comprising:
a first side panel support rod pivotally and removably disposed between the first end wall and the second end wall, the upper edge of the first side panel being fixed to the first side panel support rod; and
a first side panel adjuster extending from one of the end walls and adjustably contacting the first side panel, thereby adjusting the ash dispersal gap between the lower edge of the first side panel and the lower edge of the second side panel.

9. The combustor for solid particulate fuels according to claim 7, further comprising:
a second side panel support rod pivotally and removably disposed between the first end wall and the second end wall, the upper edge of the second side panel being fixed to the second side panel support rod; and
a second side panel stop fixed to and extending from at least one of the end walls, the second side panel stop abutting the second side panel and precluding motion thereof away from the first side panel.

10. (canceled)

11. The combustor for solid particulate fuels according to claim 7, further comprising:
a rotary agitator disposed between the first end wall and the second end wall, the agitator having;
an elongate, hollow agitator shaft defining a combustion air passage disposed axially therethrough; and
a plurality of agitator arms extending radially from the agitator shaft, each of the agitator arms defining a combustion air passage disposed axially therethrough communicating with the combustion air passage of the agitator shaft, each of the agitator arms having a plurality of combustion air outlets disposed therethrough communicating with the combustion air passage of the agitator arm.

12. The combustor for solid particulate fuels according to claim 11, wherein each of the combustion air outlets has a beveled wall defining the outlet, the beveled wall having a narrow inlet and a wide outlet.

13. The combustor for solid particulate fuels according to claim 11, wherein each of the agitator arms has a flattened distal end defining a narrow combustion air outlet slot therein.

14. A combustor for solid particulate fuels, comprising:
a first end wall;
a second end wall opposite the first end wall;
a rotary agitator disposed between the first end wall and the second end wall, the agitator having;
an elongate, hollow agitator shaft defining a combustion air passage disposed axially therethrough; and
a plurality of agitator arms extending radially from the agitator shaft each of the agitator arms defining a combustion air passage disposed axially therethrough communicating with the combustion air passage of the agitator shaft, each of the agitator arms having a plurality of combustion air outlets disposed therethrough communicating with the combustion air passage of the agitator arm, wherein each of the combustion air outlets has a beveled wall defining the outlet, the beveled wall having a narrow inlet and a wide outlet.

15. (canceled)

16. The combustor for solid particulate fuels according to claim 14, wherein each of the agitator arms has a flattened distal end defining a narrow combustion air outlet slot therein.

17. The combustor for solid particulate fuels according to claim 14, further comprising opposing first and second side panels extending between the first end wall and the second end wall, each of the side panels having a generally J-shaped cross section with a generally vertical upper portion defining an upper edge and a curved lower portion defining a lower edge, the side panels being disposed in mirror image to one another, the lower edges of the side panels facing one another and defining an adjustable ash dispersal gap therebetween.

18. The combustor for solid particulate fuels according to claim 17, further comprising:
a first side panel support rod pivotally and removably disposed between the first end wall and the second end wall, the upper edge of the first side panel being fixed to the first side panel support rod; and
a first side panel adjuster extending from one of the end walls and adjustably contacting the first side panel, thereby adjusting the ash dispersal gap between the lower edge of the first side panel and the lower edge of the second side panel.

19. The combustor for solid particulate fuels according to claim 17, further comprising:
a second side panel support rod pivotally and removably disposed between the first end wall and the second end wall, the upper edge of the second side panel being fixed to the second side panel support rod; and
a second side panel stop fixed to and extending from at least one of the end walls, the second side panel stop abutting the second side panel and precluding motion thereof away from the first side panel.

20. The combustor for solid particulate fuels according to claim 17, wherein the lower edges of the first side panel and the second side panel each have a continuous bevel disposed therealong, the ash dispersal gap having a narrow inlet and a wide outlet extending continuously along the first side panel and the second side panel.
